(19) United States
(12) Patent Application Publication
(10) Pub. No.: US 2016/0086628 A1
(43) Pub. Date: Mar. 24, 2016

(54) Optical Component Positioning Device and Optical Recording Device Using Same

(71) Applicant: Hitachi, Ltd., Chiyoda-ku, Tokyo (JP)

(72) Inventors: Jiro HASHIZUME, Tokyo (JP); Kazuyoshi YAMAZAKI, Tokyo (JP); Seiichi KATOU, Tokyo (JP); Katsuhiko KIMURA, Tokyo (JP)

(21) Appl. No.: 14/890,970

(22) PCT Filed: May 22, 2013
(86) PCT No.: PCT/JP2013/064257

§ 371 Date: Nov. 13, 2015

(51) Int. Cl. G11B 7/1353; G02B 26/08

(52) U.S. Cl. CPC G11B 7/1353; G02B 26/08

(57) ABSTRACT

Diffracted light generated by a recording medium in reproduction is largely blocked by a spatial filter because of a position shift of the recording medium. Thus, the light amount of the diffracted light converged onto an optical detector is reduced and a satisfactory level of a reproducing signal cannot be obtained. In addition, in recording, it is necessary to fix the position of the spatial filter in rays for removing unnecessary frequency components or the like in a light beam emitted from a light source. In actuators having at least two spatial filters, one spatial filter is mounted on an actuator driven along two or more axes and moves independently of another spatial filter, and the other spatial filter is fixed to a common one-axis actuator. Switching of the positions of the spatial filters is performed by the common one-axis actuator.

### TECHNICAL FIELD

The present invention relates an optical component positioning device in an optical recording device using a recording medium in the form of flat plate, and an optical recording device using that optical component positioning device.

### BACKGROUND ART

Recently, the capacity of an optical disk as one of main information recording media has been increasing with increase in the amount of electronic information that accompanies the spread of the Internet, improvement of an image quality, and the like. The increase in the capacity has been achieved as a CD, a DVD, and a BD by reduction in the size of a converged spot by increasing numerical aperture of an objective lens and shortening of a waveform of a light beam (rays) and multilayered recording layers, for example. However, a new storage technique different from the conventional techniques is required for achieving further increase in the capacity.

A hologram memory is known as a promising next generation technology of optical storages. In general, in the hologram memory, the intensity of a signal light beam (rays) is two-dimensionally modulated by a spatial light modulator (SLM). The signal light beam is made to interfere with a reference light beam, so that a pattern of the interference is fixed in a disk-shaped recording medium (an optical disk) as distribution of refractive index. In this manner, information is recorded. In addition, a plurality of kinds of information can be simultaneously recorded to one recording portion by changing an angle of incidence of the reference light beam on the recording medium.

In reproduction of information in the hologram memory, when the reference light beam used in recording is radiated onto the recording medium at the same angle as that in recording, diffracted light is generated from the interference pattern fixed in the recording medium. The recorded information is reproduced by receiving the diffracted light with an optical detector. In this manner, the hologram memory allows a plurality of kinds of two-dimensional information to be recorded and reproduced to/from one recording portion, and therefore enables recording and reproduction of the information with high density at a high speed.

Patent Literatures 1 and 2 describe examples of a driving device that switches an optical component for recording and an optical component for reproduction or controls a position of a converged point of a light beam three-dimensionally for two different conditions of use, for example, for recording and for reproduction described above, in a manner appropriate to those conditions.

Patent Literature 1 describes an objective lens driving device and an optical head device for performing recording and reproduction for a plurality of different kinds of optical information recording media that are different in a substrate thickness, recording sensitivity, or the like with a single optical information recording/reproducing apparatus. To achieve this, the objective lens driving device and the optical head device are configured to make a light spot converged onto an information recording surface of each optical information recording medium most appropriate for that medium, and to accurately control a track shift and a focus shift. More specifically, Patent Literature 1 describes the objective lens driving device including a lens holder held to be movable around an axial line and be movable up and down along the axial line, a plurality of objective lenses provided in the lens holder at positions away from the axial line with approximately equal distances from the axial line, a driving device that moves the lens holder up and down along the axial line and around the axial line to drive a light spot on the optical information recording medium in a focus direction and in a direction crossing tracks, and means that determines the kind of the optical information recording medium, wherein, in the objective lens driving device, one of the objective lenses is selected in accordance with the type of the optical information recording medium and is moved into a light bundle to form the light spot, so that information is recorded or reproduced. Patent Literature 1 also describes the optical head device including that objective lens driving device.

Patent Literature 2 describes an optical head including a first lens that converges a collimated light beam from a light source unit, a second lens that converts the converged light beam to a collimated light beam again, and a third lens that converges the collimated light beam onto a recording surface of an optical disk. The optical head performs adjustment of a focus position of the light beam by moving the third lens in its optical axis direction, and performs tracking control of the light beam by moving one of the first lens and the second lens in a plane perpendicular to its optical axis to incline the optical axis of the light beam incident on the third lens. In the optical head, one of the first lens and the second lens is attached to a first movable member supported by a first plate spring pivotally movable only in a plane perpendicular to the optical axis of the one of the first and second lenses, and the third lens is attached to a second movable member supported by a second plate spring pivotally movable only in a plane perpendicular to the tracking direction. It is described that due to this configuration, a position of a converged point of a light beam transmitted through the lens is moved in a normal plane with respect to the optical axis of the light beam by moving the lens in the normal plane with respect to the optical axis, and is moved in the optical axis direction by moving the objective lens in the optical axis direction.

### CITATION LIST

### Patent Literature

Patent Literature 1: Japanese Unexamined Patent Application Publication No. Hei8(1996)-221779
Patent Literature 2: Japanese Unexamined Patent Application Publication No. Hei4(1992)-13233

### SUMMARY OF INVENTION

### Technical Problem

In an optical recording device using a recording medium in the form of flat plate, for example, the hologram memory described above, a position or an angle of the recording medium with respect to a position of a reference light beam is changed while the recording medium in the form of flat plate is rotating, because of specific deflection, vibration, or the like of the recording medium. With this change of the position or the angle, a position or an angle of reproducing light (i.e., diffracted light) generated by the recording medium in reproduction is changed, so that a position of a converged point of the reproducing light converged on an optical component, for example, a spatial filter, arranged in an optical path between the recording medium and the optical detector is three-dimensionally changed. When the position of the converged point of the reproducing light is changed on the spatial filter, the reproducing light is blocked by the spatial filter, causing reduction in the light amount of the reproducing light converged on the optical detector and preventing a satisfactory level of a reproducing signal from being obtained. Therefore, there is a problem that the spatial filter has to be moved to the most appropriate position in synchronization with the position or the angle of the recording medium.

On the other hand, when recording is performed by the optical recording device using the recording medium in the form of flat disk such as the hologram memory described above, it is necessary to fix the position of the optical component such as the spatial filter to the center of the signal light beam irrespective of the position of the recording medium for removing unnecessary frequency components or the like contained in the signal light beam emitted from a light source. Further, there is a problem that the position of the spatial filter has to be fixed accurately, although it is difficult to continuously acquire position information of the spatial filter by using the signal light beam transmitted through the spatial filter and continuously perform feedback control of the position of the spatial filter because the signal light beam is radiated discretely and discontinuously for a short period of time in recording.

However, the configuration of the driving device for the optical head in Patent Literature 1 only enables driving of the position of the converged point of the light beam in a direction along one axis on the normal plane with respect to the optical axis by switching the optical components by means of an actuator driven along the one axis on the normal plane with respect to the optical axis, and driving of it in the normal direction by an actuator driven along the optical axis direction. In other words, the position of the converged point of the light beam can be driven only in two axial directions. Further, because the driving device uses the principle of electromagnetic driving, the positioning state is unstable and it is therefore difficult to fix the optical component during recording.

On the other hand, in the configuration of Patent Literature 2, the position of the converged point of the light beam can be three-dimensionally driven to an arbitrary position. However, when the lens is displaced from the center of the optical axis for driving the position of the converged point of the rays, distortion of the light beam is caused, thus degrading a recording/reproducing signal. Furthermore, because the driving device uses the principle of electromagnetic driving, the positioning state is unstable and it is therefore difficult to fix the optical component during recording. In addition, the configuration of Patent Literature 2 also has a problem that driving for switching the optical components between recording and reproduction cannot be performed.

The present invention has been made in view of the above-described problems, and aims to provide an optical component positioning device that can switch optical components such as spatial filters, between recording and reproduction, can move the optical component to the most appropriate position in synchronization with a position or an angle of a recording medium, and can accurately fix the position of the optical component such as the spatial filter when fixing is required, for example, during recording, and to provide an optical recording device using that optical component positioning device.

### Solution to Problem

The present invention can be understood from a plurality of aspects. According to one aspect, a typical optical component positioning device of the present invention and an optical recording device using it are as follows. Further, the optical component positioning device of the present invention and the optical recording device using it according to another aspect will be more apparent by the following description of embodiments of the invention and the like.

The optical component positioning device of the present invention is an optical component positioning device that moves at least two optical components arranged in an optical path of a light beam emitted from a light source to position them at predetermined positions, and includes a first actuator on which the two optical components are mounted and which moves the two optical components together and is driven along one axis, a second actuator on which a first optical component of the two optical components is mounted and which moves the first optical component independently of another second optical component and is driven along two or more axes, and a control device which controls the first actuator and the second actuator.

The optical recording device of the present invention using the above optical component positioning device is an optical recording device including a rotary motor driving a recording medium mounted thereon to rotate and a head recording and reproducing a signal to/from the recording medium. The recoding/reproducing head has at least two optical components arranged in an optical path of a light beam emitted from a light source. The head also includes an optical component positioning device including a first actuator on which the two optical components are mounted and which moves the two optical components together and is driven along one axis, a second actuator on which a first optical component of the two optical components is mounted and which moves the first optical component independently of another second optical component and is driven along two or more axes, and a control device controlling the first actuator and the second actuator.

### Advantageous Effects of Invention

According to the present invention, it is possible to provide an optical component positioning device that can suppress degradation of a reproducing signal caused by deflection of a recording medium (an optical disk) or a shift of the recording medium caused by vibration during rotation of the recording medium in a direction of a rotation axis and in a direction within a normal plane with respect to the rotation axis, and to provide an optical recording device using that optical component positioning device. Thus, it is also possible to provide a high-density and high-speed hologram memory.

### BRIEF DESCRIPTION OF DRAWINGS

FIG. 1 is a diagram showing an example of an entire structure of a hologram memory device;

FIG. 2(a) is a diagram explaining an operation example of a displacement correction mechanism 402 when a position of a recording medium is shifted in an embodiment of the present invention;

FIG. 2(b) is a diagram explaining another operation example of the displacement correction mechanism 402 when the position of the recording medium is shifted in the embodiment of the present invention;

FIG. 2 (c) is a diagram explaining still another operation example of the displacement correction mechanism 402 when the position of the recording medium is shifted in the embodiment of the present invention;

FIG. 3 (a) is a diagram showing a configuration of the displacement correction mechanism 402 in the embodiment of the present invention;

FIG. 3(b) is a diagram showing a configuration of a two-axis actuator 404 of the displacement correction mechanism 402 in the embodiment of the present invention;

FIG. 4(a) is a diagram explaining the configuration and an operation of the two-axis actuator 404 of the displacement correction mechanism 402 in the embodiment of the present invention;

FIG. 4 (b) is a diagram explaining an example of a relation between a driving force and a displacement in the two-axis actuator 404 of the displacement correction mechanism 402 in the embodiment of the present application;

FIG. 4(c) is a diagram explaining another example of the relation between the driving force and the displacement in the two-axis actuator 404 of the displacement correction mechanism 402 in the embodiment of the present invention;

FIG. 5 is a diagram showing a configuration of a one-axis actuator 403 of the displacement correction mechanism 402 in the embodiment of the present invention;

FIG. 6(a) is a diagram explaining a configuration of an optical component switching mechanism of the displacement correction mechanism 402 and an operation thereof during recording in the embodiment of the present invention;

FIG. 6 (b) is a diagram explaining the configuration of the optical component switching mechanism of the displacement correction mechanism 402 and an operation thereof during reproduction in the embodiment of the present invention; and

FIG. 7 is a diagram showing a configuration of a spatial filter 212 in in the embodiment of the present invention.

### DESCRIPTION OF EMBODIMENTS

An optical recording device according to an embodiment of the present invention includes a rotary motor driving a recording medium mounted on the optical recording device to rotate, and a head recording and reproducing a signal to/from the recording medium, for example. The recording/reproducing head includes at least two optical components, and has an optical component positioning device that performs position control for the two optical components with a common one-axis actuator and performs position control for one of the two optical components with an actuator driven along two or more axes in such a manner that the one optical component moves independently of another optical component.

In the optical component positioning device and the optical recording device using the same according to the embodiment of the present invention, the common one-axis actuator switches the two optical components.

In the optical component positioning device and the optical recording device using the same according to the embodiment of the present invention, a position of the common one-axis actuator is fixed when no current is supplied thereto.

In the optical component positioning device and the optical recording device using the same according to the embodiment of the present invention, the recording medium mounted on the optical recording device is rotatable, and the one-axis actuator moves in such a manner that a position on the recording medium at which rays transmitted through the optical component positioning device are incident on the recording medium moves in a normal direction with respect to a rotation axis of the recording medium.

In the optical component positioning device and the optical recording device using the same according to the embodiment of the present invention, the optical components change intensity, polarization, and an angle of the rays transmitted therethrough.

The optical component positioning device and the optical recording device using the same according to the embodiment of the present invention has a function of detecting a position of the rays transmitted through the optical component.

Embodiments of the present invention are described in detail below, with reference to the drawings. The following description is intended to indicate the embodiments of the present invention, but is not intended to limit the present invention to the embodiments. The present invention can be changed or modified by those skilled in the art in various ways within the scope of the technical spirit disclosed in the present specification. Throughout the drawings for explaining the embodiments and specific examples, components having the same function are labeled with the same reference sign and the redundant description thereof may be omitted.

### [Entire Configuration of Hologram Memory Device]

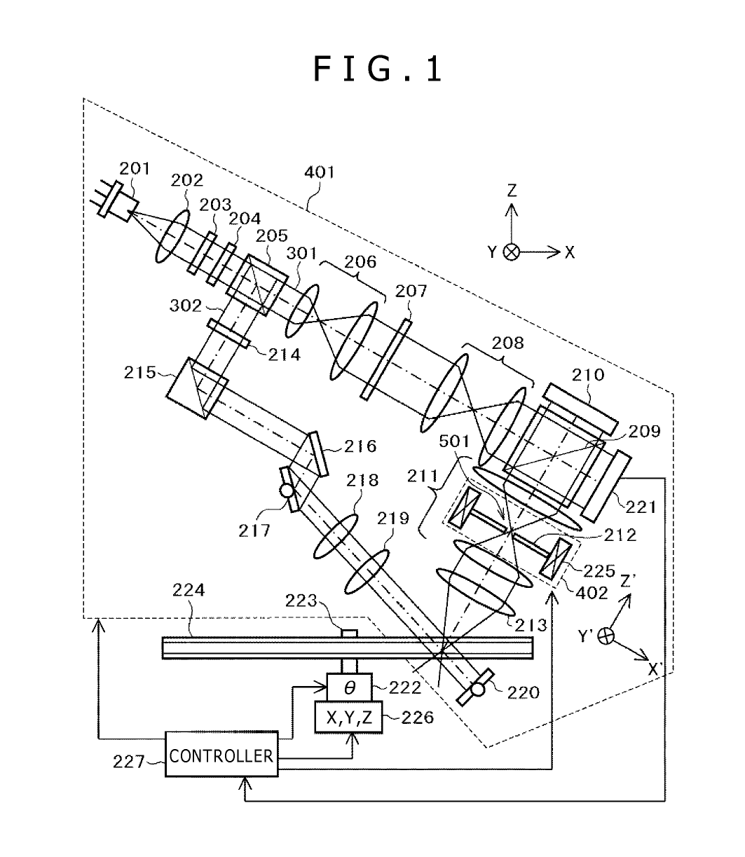

FIG. 1 is a diagram generally explaining an example of an entire structure of a hologram memory device, and in particular shows an example of a configuration of an optical head portion 401 in detail.

A light beam (rays) emitted from a light source 201 is transmitted through a collimate lens 202. At a shutter 203, a time period in which the light beam passes therethrough is limited. After passing through the shutter 203, the light beam is subjected to control of a ratio of P-polarized light and S-polarized light in a half-wave plate 204 and is thereafter incident on a polarized beam splitter 205. A signal light (for example, a P-polarized light) beam 301 transmitted through the polarized beam splitter 205 is enlarged in its diameter by a beam expander 206, is thereafter transmitted through a phase mask 207 and a relay lens 208, is reflected by a polarized beam splitter 209, and is incident on a spatial light modulator 210. The signal light beam 301 to which information is added by the spatial light modulator 210 is transmitted through the polarized beam splitter 209, is then transmitted through a relay lens 211, a spatial filter 212, and an objective lens 213, and is converged onto a recording medium 224.

A reference light (for example, an S-polarized light) beam 302 reflected by the polarized beam splitter 205 is subjected to control in a polarized direction conversion element 214 to have a polarized direction in accordance with recording or reproduction, is then reflected by a mirror 215 and a mirror 216, and is radiated onto a galvano mirror 217. A reflection angle of the reference light beam 302 is controlled by the galvano mirror 217, and thereafter the reference light beam 302 is transmitted through a lens 218 and a lens 219 and is then incident on the recording medium 224. An angle of incidence of the reference light beam 302 on the recording medium 224 is adjusted by controlling the angle of the reference light beam 302 by the galvano mirror 217.

When the signal light beam 301 and the reference light beam 302 are superimposed in the recording medium 224, an interference pattern formed by the signal light beam 301 and the reference light beam 302 is recorded within the recording medium 224, by which information is recorded. When the angle of the reference light beam 302 incident on the recording medium 224 is changed by the galvano mirror 217, recording depending on the angle of incidence can be achieved. Therefore, recording in angular multiplexing can be achieved.

When the information recorded in the recording medium 224 is reproduced, a light beam emitted from the light source 201 is adjusted in the aforementioned half-wave plate 204 to have one of the P-polarized light and the S-polarized light that is used as the reference light in such a manner that the whole amount of the light beam forms a reference light (for example, an S-polarized light) beam 302 that is to be reflected by the polarized beam splitter 205. The reference light beam 302 is incident on the recording medium 224 by passing through the components in the same order as that for the aforementioned reference light beam 302, is transmitted through the recording medium 224, and is then reflected by a galvano mirror 220. When the reference light beam 302 reflected by the galvano mirror 220 is incident on the recording medium 224 again, reproduction light diffracted by the interference pattern recorded in the recording medium 224 is generated. The reproduction light is transmitted through the objective lens 213, the relay lens 211, and the spatial filter 212, and is then reflected by the polarized beam splitter 209 to be incident on an optical detector 221 in which a recorded signal is reproduced. The galvano mirror 217 and the galvano mirror 220 are moved in conjunction with each other, so that the reference light beam 302 can be incident on the recording medium 224 at a plurality of angles of incidence that are the same as those during recording. Therefore, information recorded in a multiplexing manner can be reproduced.

The recording medium 224 is fixed to a rotary motor 222 via a rotation shaft 223, and the rotary motor 222 is fixed onto a stage 226. Thus, a position in the recording medium 224 at which recording/reproduction is performed can be set in an arbitrary manner by controlling a rotation angle with the rotary motor 222 and positions in X-, Y-, and Z-axis directions with the stage 226 through control with a control device (controller) 227 of the optical recording device.

The control device (hereinafter, referred to as the controller) 227 performs various types of control of the optical head 401. For example, the controller 227 controls emission of the light beam from the light source, the angles of the galvano mirrors 217 and 220, and the position of the spatial filter 212 in accordance with a signal of detected light in the optical detector 221.

### [Correction of Position Shift and Inclination of Recording Medium During Reproduction]

Next, an operation of a displacement correction mechanism 402 is described when the position of the recording medium 224 is shifted or the recording medium 224 is inclined.

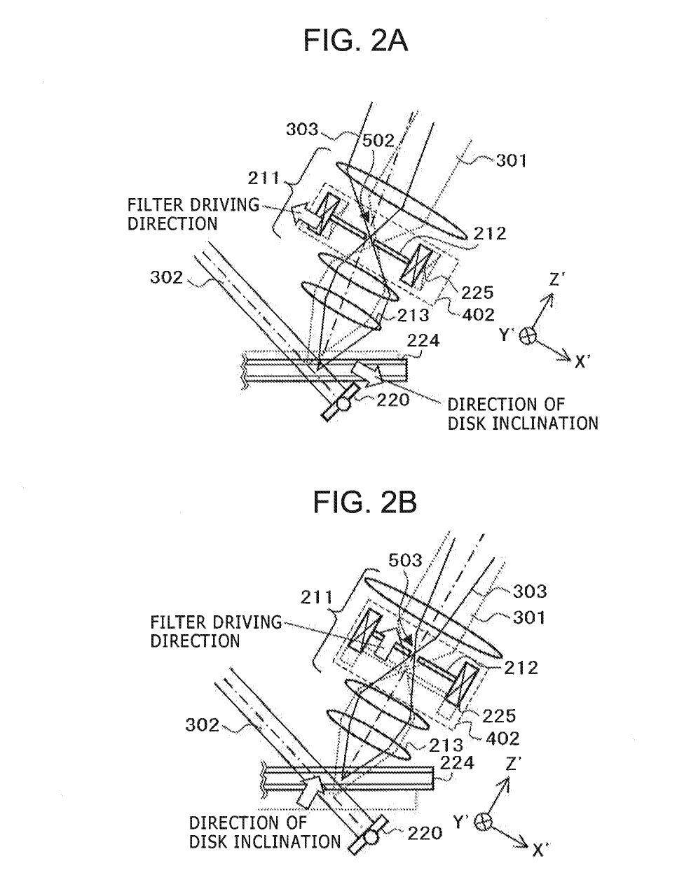

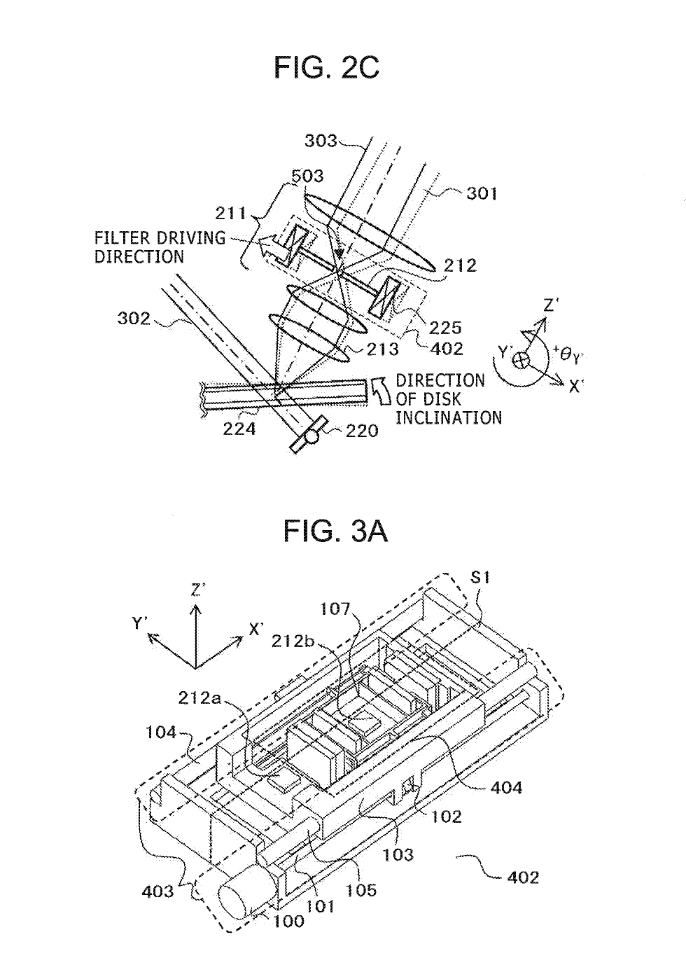

In FIGS. 2(a), (b), and (c), the variation correction mechanism 402 of the optical component positioning device of the present invention is provided with an actuator 225 for positioning the spatial filter 212 and moves the spatial filter 212.

FIG. 2(a) is a diagram explaining an operation of the displacement correction mechanism 402 in reproduction of information recorded in the recording medium 224 in this embodiment, in a case where the recording medium 224 is shifted toward a direction of one axis (+X′-axis direction) on a normal plane with respect to the optical axis of the signal light beam 301 used in recording. The position shown with dotted line is the original position of the recording medium 224.

FIG. 2 (b) is a diagram explaining an operation of the displacement correction mechanism 402 in a case where the recording medium 224 is shifted toward a direction of the optical axis (+Z′-axis direction) of the signal light beam 301 used in recording in this embodiment. A position shown with dotted line is an original position of the recording medium 224.

FIG. 2(c) is a diagram explaining an operation of the displacement correction mechanism 402 in a case where the recording medium 224 is inclined (in +θ_{γ′} direction) with respect to the optical axis of the signal light beam 301 used in recording in this embodiment. The position shown with dotted line is the original position of the recording medium 224.

As shown in FIG. 2(a), when the recording medium 224 is shifted toward the direction of one axis (+X′-axis direction) on the normal plane with respect to the optical axis of the signal light beam 301 used in recording, a position at which a reproducing light beam 303 diffracted by the information recorded in the recording medium 224 is generated is also shifted toward a direction of one axis (−X′-axis direction) on the normal plane with respect to the optical axis of the signal light beam 301 simultaneously. Thus, a converged point 501 in the displacement correction mechanism 402 is displaced to a position 502 toward −X′ direction, so that the reproducing light beam 303 is largely blocked by the spatial filter 212 and the light amount thereof is decreased, resulting in degradation of a reproducing signal. Therefore, the spatial filter 212 is moved by the actuator 225 toward the direction of one axis (−X′-axis direction) on the normal plane with respect to the signal light beam 301 to recover the light amount of the diffracted light converged on the optical detector 221 and compensate the degradation of the reproducing signal.

As shown in FIG. 2(b), when the recording medium 224 is shifted toward the normal direction (+Z′-axis direction) with respect to the optical axis of the signal light beam 301 used in recording, the position at which the reproducing light beam 303 diffracted by the information recorded in the recording medium 224 is generated is also shifted toward the optical axis direction (+Z′-axis direction) of the signal light beam 301 simultaneously. Thus, the point 501 at which the reproducing light beam 303 is converged in the displacement correction mechanism 402 is displaced toward +Z′ direction to a position 503, so that the reproducing light beam 303 is blocked by the spatial filter 212 and degradation of the reproducing signal is caused, as in the case of FIG. 2(a). Therefore, the spatial filter 212 is moved by the actuator 225 toward the optical axis direction (+Z′-axis direction) of the signal light beam 301 to compensate the degradation of the reproducing signal.

Finally, when the recording medium 224 is inclined (in +θ_{γ′} direction) with respect to the optical axis of the signal light beam 301 used in recording as shown in FIG. 2(c), the information (that is, the interference pattern) recorded in the recording medium 224 is inclined and therefore an angle of the reference light beam 303 that is diffracted is also inclined with respect to the optical axis of the signal light beam 301 (in +θ_{γ′} direction) simultaneously. This inclination causes displacement of the point 501 at which the reproducing light beam 303 is converted in the displacement correction mechanism 402 toward −X′ direction to the position 503, so that the reproducing light beam 303 is blocked by the spatial filter 212 and the reproducing signal is degraded, as in the case of FIG. 2(a). Therefore, the degradation of the reproducing signal is compensated by moving the spatial filter 212 by the actuator 225 toward the direction direction of one axis (−X′-axis direction) on the normal plane with respect to the signal light beam 301.

### [Operation of Displacement Correction Mechanism]

Next, a specific operation of the displacement correction mechanism 402 controlling the position of the spatial filter 212 is described.

As shown in FIG. 1, the hologram memory device 401 uses the rotary motor 222 and the translating stage 226 for moving the disk-shaped recording medium 224 to a position at which recording and reproduction is performed. Rotational positioning of the recording medium using the rotary motor 222 can be achieved at a higher speed as compared with positioning using the translating stage 226 (that is translated in a normal direction with respect to the rotation shaft, that is, in a radial direction). Therefore, while the spatial filter 212 is required to be driven at a high speed in a rotation direction (Y′-axis direction) and in the optical axis direction (Z′-axis direction) in which a shift is caused in association with the rotation, the spatial filter 212 can be driven in X′-axis direction that is the normal direction with respect to the rotation shaft at a relatively low speed. In this embodiment, an electromagnetically driven actuator is used as an actuator for Y′-axis direction and Z′-axis direction in both of which high-speed driving is required, and a lead screw mechanism using a motor is used as an actuator for X′-axis direction in which relatively low-speed driving is allowed.

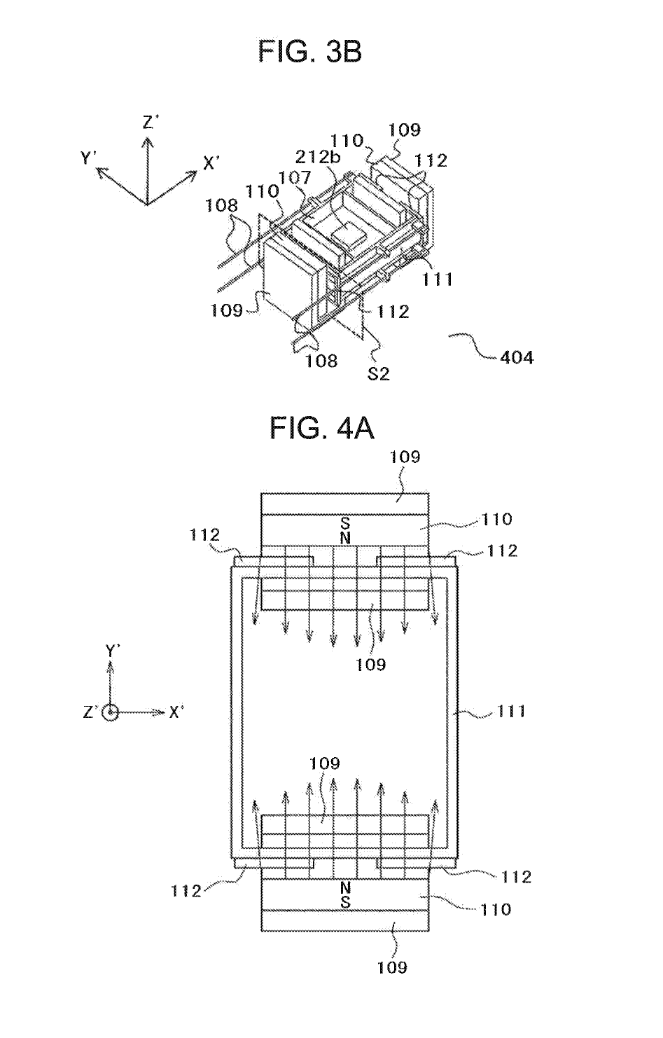

FIG. 3(a) is a diagram explaining a configuration of the displacement correction mechanism 402. FIG. 3(b) is a diagram explaining a configuration of a two-axis actuator 404 of the displacement correction mechanism 402, which drives a spatial filter 212b in two axial directions, that is, in the optical axis direction (Z′-axis direction) and in one axial direction (Y′-axis direction) on the normal plane with respect to the optical axis by electromagnetic driving.

The displacement correction mechanism 402 has two spatial filters 212a and 212b. The spatial filter 212a is fixed to a one-axis (X′-axis) driving holder 103, and the spatial filter 212b is fixed to a two-axis (Y′-axis and Z′-axis) driving holder 107.

First, an operation of the two-axis actuator 404 is described below.

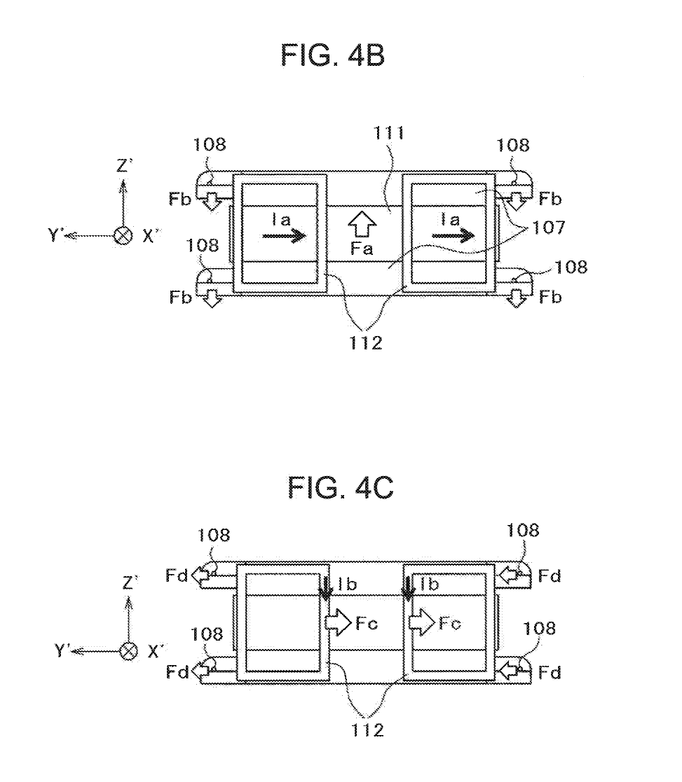

FIG. 4(a) is a diagram for explaining the operation of the actuator 404 driven along two axes formed by an electromagnetically driven actuator, in which main components of the actuator 404 driven along two axes (hereinafter, referred to as a two-axis actuator) are seen toward −Z-axis direction.

FIGS. 4(b) and 4(c) are diagrams for explaining driving forces generated in the two-axis actuator 404 in the optical axis direction (Z′-axis direction) and the one axial direction (Y′-axis direction) on the normal plane with respect to the optical axis, respectively, in which the two-axis actuator 404 is seen toward +X-axis direction in a cross section S2 in FIG. 3(b).

In the two-axis actuator 404, two types of coils 111 and 112 fixed to the two-axis driving holder 107 are arranged in a magnetic field formed by magnets 110 and yokes 109 provided outside the holder 107, as shown in FIGS. 3(b) and 4(a).

As shown in FIG. 4(b), the coil 111 for driving in the optical axis direction is fixed to a periphery of the two-axis actuator holder 107. When a driving current Ia flows through the coil 111 for driving in the optical axis direction, the Lorentz force Fa is generated in the optical axis direction (+Z′-axis direction) and the holder 107 is displaced in the optical axis direction (+Z′-axis direction). Wires 108 are fixed to the one-axis driving holder 103 at ends in −X′ direction and to the two-axis actuator holder 107 at ends in +X′-direction. Therefore, the two-axis driving holder 107 is supported by four wires 108 fixed to the one-axis driving holder 103 in a cantilever manner and, when the two-axis driving holder 107 is displaced in the optical axis direction (+Z′-axis direction), a spring force Fb is generated. Thus, the two-axis actuator holder 107 is fixed at a position where the Lorentz force Fa and the spring force Fb are balanced.

On the other hand, two pairs of coils 112 for the normal direction of the optical axis are arranged in gaps between the magnets 110 and the yokes 109, and are fixed on two surfaces of the two-axis driving holder 107 in an axial direction of the wires 108. As shown in FIG. 4(c), when a driving current Ib flows through the coils 112, the Lorentz force Fc is generated in the normal direction (−Y′-axis direction) of the optical axis and the two-axis driving holder 107 is displaced in the normal direction (−Y′-axis direction) of the optical axis. The two-axis driving holder 107 is positioned and fixed at a position where a spring force Fd and the Lorentz force Fc are balanced, as in the case where the coil 111 for driving in the optical axis direction is energized. (Note that effects of gravity are not described here.)

The two-axis actuator 404 controls the position in Y′-axis direction and that in Z′-axis direction of the spatial filter 212b with the currents applied to the coils 111 and 112 in accordance with the above operation principle.

Next, an operation of the actuator driven along one axis (hereinafter, the one-axis actuator) 403 is described below.

The one-axis actuator 403 that can be driven at a relatively low speed is formed mainly by a stepping motor 100, a lead screw 101, a nut 102, and two guide rails 104 and 105, as shown in FIG. 3(a). The nut 102 is fixed to the one-axis driving holder 103 of the displacement correction mechanism 402.

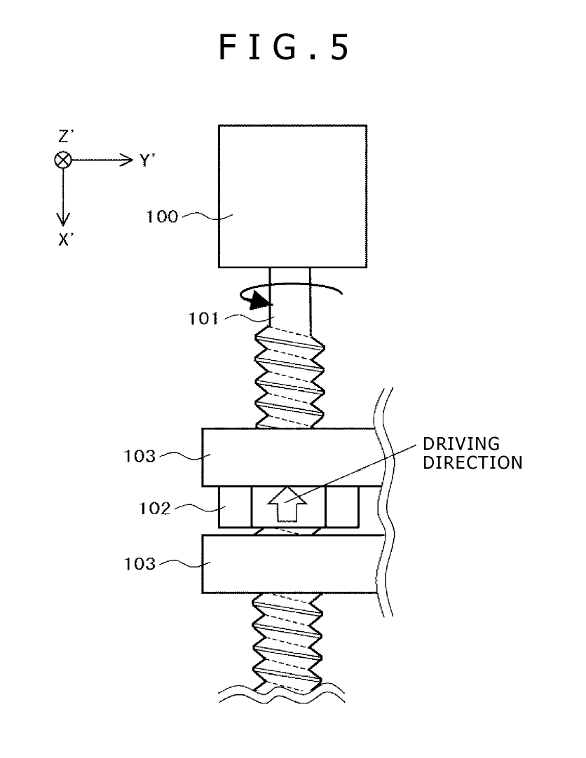

FIG. 5 is a diagram explaining the lead screw mechanism of the one-axis actuator 403 of the displacement correction mechanism 402.

When the stepping motor 100 rotates around X′-axis, the nut 102 fixed to the one-axis driving holder 103 and the one-axis driving holder 103 are displaced in X′-axis direction that is an axial direction of the two guide rails 104 and 105. Because the stepping motor 100 has such characteristics that a rotation angle of the lead screw 101 is maintained while no current is supplied to the stepping motor 100, the position of the one-axis driving holder 103 is fixed.

Based on the above operation principle, the one-axis actuator 403 controls the positions in X′-axis direction of the spatial filter 212a and the spatial filter 212b that are mounted on the one-axis driving holder 103 by the number of pulses of a voltage applied to the stepping motor 100. Further, the one-axis actuator 403 is used not only for minute position control for the spatial filter 212a and the spatial filter 212b but also for switching of the spatial filter 212a and the spatial filter 212b during recording and reproduction.

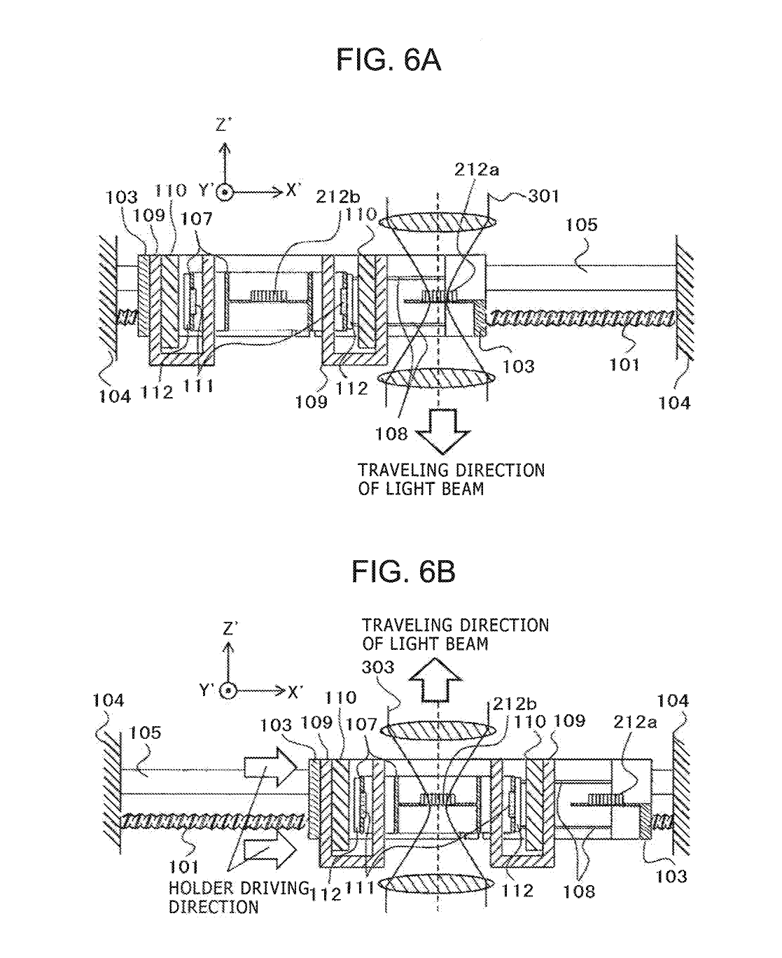

FIGS. 6 (a) and 6 (b) are cross-sectional views of the displacement correction mechanism 402 shown in FIG. 3 (b) for explaining the switching operation of the one-axis actuator 403 during recording and reproduction, in which cross sections cut along an X′Z′ coordinate surface 51 are seen toward −Y′-axis direction.

As shown in FIG. 6(a), during recording, the signal light beam 301 is transmitted through the spatial filter 212a fixed to the one-axis driving holder 103. Because the spatial filter 212a is fixed to the one-axis driving holder 103, the positions thereof in Y′-axis direction and Z′-axis direction do not change. The position of the spatial filter 212a in X′-axis direction is uniquely determined by the number of pulses of the voltage input to the stepping motor 100 of the one-axis actuator 403, and therefore can be controlled by an open loop that does not require a feedback signal.

During reproduction, as shown in FIG. 6(b), the spatial filer 212b mounted on the two-axis actuator 404 is moved by the one-axis actuator 403 to a position at which the reproducing light beam 303 is transmitted through the spatial filter 212b. Because the spatial filter 212b is fixed to the two-axis actuator 404 mounted on the one-axis actuator 403, the position in X′-axis direction of the spatial filter 212b is controlled by the number of pulses of the voltage input to the stepping motor 100 of the one-axis actuator 403, and the positions in Y′-axis direction and Z′-axis direction are controlled by the driving currents Ia and Ib respectively applied to the coils 111 and 112 of the two-axis actuator 404. The amount of the position shift between the position 501 of the converged point of the reproducing light beam 303 and the spatial filter 212b shown in FIG. 2 is estimated in accordance with detected light (e.g., an intensity thereof) obtained by detecting the reproducing light beam 303 blocked by the spatial filter 212b of the displacement correction mechanism 402 shown in FIG. 1 with a detector, e.g., the optical detector 221. The displacement correction mechanism 402 is controlled by the thus estimated position shift amount. In the estimation of the detected light, a detector other than the optical detector 221 may be used, so long as it can estimate the light exiting from the spatial filter 212b. By controlling the spatial filter 212b by the controller 227 to be positioned at a position at which the reproducing light beam 303 detected by the optical detector 221 is maximum, the position shift between the position 501 of the converged point of the reproducing light beam 303 and the spatial filter 212b can be made minimum.

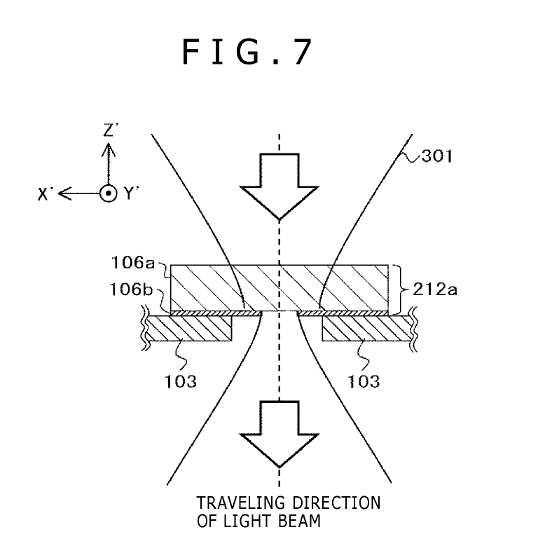

FIG. 7 is a cross-sectional view of the spatial filter 212a mounted on the one-axis actuator 403 around the optical axis, for explaining the configuration of the spatial filter 212. The spatial filter 212a is formed by a thin film 106b that blocks transmission of the signal light beam 301 therethrough and a transparent substrate 106a supporting the thin film 106b. The spatial filter 212b is fixed to the one-axis driving holder 103 having a structure in which a region through which the signal light beam 301 is transmitted is formed as a hole. Due to this structure, the spatial filter 212b acts as a spatial filter limiting the region of the transmitted signal light beam 301, as shown in FIG. 7.

The two-axis actuator 404 and the one-axis actuator 403 in this embodiment are described as being electromagnetically driven and being driven by a motor, respectively. However, an actuator such as an ultrasonic motor, can be used as the one-axis actuator 403, so long as it can provide the same effects.

In this embodiment, a case is described where the displacement correction mechanism 402 is used in the hologram memory device. However, the displacement correction mechanism 402 can be applied to another optical device such as an optical inspection device.

The present invention is not limited to the above-described embodiment, and includes various modifications. For example, the above-described embodiment describes the present invention in detail for providing easy-to-understand explanation, but is not necessarily intended to limit the present invention to a device including all the described components. Further, a portion of the configuration of one embodiment can be replaced with the structure of another embodiment, and a configuration of another embodiment can be added to a configuration of one embodiment. Furthermore, addition of another configuration can be added to a portion of the configuration of each embodiment, and deletion or replacement of the portion of the configuration of each embodiment is also possible.

Although the control mechanism and the components and a combination thereof are shown that can be necessary for explanation, all the control mechanism, the components, and a combination in a product are not necessarily shown. It can be considered that all or most of the configurations are mutually related and connected.

### LIST OF REFERENCE SIGNS

100: stepping motor
101: lead screw
102: nut
103: one-axis driving holder
104: guide rail
105: guide rail
106a: thin film
106b: transparent substrate
107: two-axis driving holder
108: wire
109: yoke
110: magnet
111: coil for driving in optical axis direction
112: coils for normal direction of optical axis
201: light source
202: collimate lens
203: shutter
204: half-wave plate
205: polarized beam splitter
206: beam expander
207: phase mask
208: relay lens
209: polarized beam splitter
210: spatial light modulator
211: relay lens
212: spatial filter
213: objective lens
214: polarized direction conversion element
215: mirror
216: mirror
217: galvano mirror
218: lens
219: lens
220: galvano mirror
221: optical detector
222: rotary motor
223: rotation shaft
224: recording medium
225: actuator
226: stage
227: controller (control device)
301: signal light beam
302: reference light beam
303: reproducing light beam
401: hologram memory device
402: displacement correction mechanism
403: one-axis actuator
404: two-axis actuator
501 to 505: position of the converged point

1.-15. (canceled)

16. An optical component positioning device moving at least two optical components arranged in an optical path of a light beam emitted from a light source to position the at least two optical components at predetermined positions, comprising:
a first actuator, on which the two optical components are mounted, configured to move the two optical components together and be driven along one axis;
a second actuator, on which a first optical component of the two optical components is mounted, configured to move the first optical component independently of another second optical component and be driven along or more axes; and
a control device configured to control the first actuator and the second actuator,
wherein the first actuator mechanically holds positions of the optical components, and
the first and second optical components are formed by mutually replaceable optical systems.

17. The optical component positioning device according to claim 16, wherein the first and second optical components are switched by movement by the first actuator driven along the one axis.

18. The optical component positioning device according to claim 17, wherein the first actuator driven along the one axis is formed by a motor-driven actuator, and the positions of the first and second optical components are fixed while no current is supplied to the motor-driven actuator.

19. The optical component positioning device according to claim 16, wherein the second actuator driven along the two or more axes is formed by an electromagnetically driven actuator, and the position of the first optical component is determined by energization control of the electromagnetically driven actuator.

20. The optical component positioning device according to claim 16, wherein at least one of the first and second optical components changes at least one of an intensity, polarization, and an angle of the light beam transmitted therethrough.

21. The optical component positioning device according to claim 16, further comprising an optical detector configured to optically detect the light beam transmitted through the first optical component.

22. An optical recording device including a rotary motor that drives a recording medium mounted thereon to rotate and a head that records and reproduces a signal to/from the recording medium, the recording/reproducing head having at least two optical components arranged in an optical path of a light beam emitted from a light source,
wherein the head includes an optical component positioning device including: a first actuator on which the two optical components are mounted and which moves the two optical components together and is driven along one axis; a second actuator on which a first optical component of the two optical components is mounted and which moves the first optical component independently of another second optical component and is driven along two or more axes; and a control device controlling the first actuator and the second actuator,
the first actuator mechanically holds positions of the optical components, and
the first and second optical components are formed by mutually replaceable optical systems.

23. The optical recording device according to claim 22, wherein the optical component positioning device switches the first and second optical components by movement by the first actuator driven along the one axis.

24. The optical recording device according to claim 23, wherein in the optical component positioning device, the first actuator driven along the one axis is formed by a motor-driven actuator, and the positions of the first and second optical components are fixed while no current is supplied to the motor-driven actuator.

25. The optical recording device according to claim 22, wherein the second actuator driven along the two or more axes is formed by an electromagnetically driven actuator, and the position of the second optical component is determined by energization control of the electromagnetically driven actuator.

26. The optical recording device according to claim 22, wherein in the optical component positioning device, at least one of the first and second optical components is formed by an optical component that changes at least one of an intensity, polarization, and an angle of the light beam transmitted therethrough.

27. The optical recording device according to claim 22, wherein the optical component positioning device includes an optical detector optically detecting the light beam transmitted through the first optical component.

28. The optical recording device according to claim 22, wherein the one-axis actuator moves the first and second optical components in such a manner that a position at which the light beam transmitted through the optical component positioning device is radiated onto the recording medium that is rotating moves in a normal direction with respect to a rotation axis of the recording medium.

29. The optical recording device according to claim 28, wherein at least one of the first and second optical components changes at least one of intensity, polarization, and an angle of the light beam transmitted therethrough.

30. The optical recording device according to claim 28, further comprising an optical detector optically detecting the light beam transmitted through the first optical component.

31. The optical recording device according to claim 22, wherein a substrate forming the first and second optical components is arranged in such a manner that a main surface of the substrate is opposed to a main surface of the recording medium.
